(19) United States
(12) Patent Application Publication
(10) Pub. No.: US 2016/0021850 A1
(43) Pub. Date: Jan. 28, 2016

(54) Method and Apparatus for Determining a Location of an Animal in an Animal Control System

(71) Applicant: DOGWATCH INC., Natick, MA (US)

(72) Inventor: Norval Stapelfeld, Manchester, NH (US)

(21) Appl. No.: 14/808,328

(22) Filed: Jul. 24, 2015

Related U.S. Application Data
(60) Provisional application No. 62/029,881, filed on Jul. 28, 2014.

(51) Int. Cl. A01K 11/00; G01S 5/02; G01S 19/24; A01K 27/00; G01S 19/14

(52) U.S. Cl. CPC A01K 11/008; A01K 27/001; G01S 19/14; G01S 19/24; G01S 5/0284; G01S 5/0294

(57) ABSTRACT

An animal control system includes the capability of determining on which side of a containment structure the animal is located. Specifically, the system determines a polarity of a first half-cycle of an active portion of the signal transmitted on the enclosure wire. The determined polarity identifies if the animal is within or outside the enclosure.

### BACKGROUND OF THE INVENTION

Systems for controlling the movement of an animal using a wire-loop antenna to define a controlled area and a transmitter/controller unit to emit a Frequency Shift Keying (FSK) signal from the antenna are known. Examples of such systems are found in U.S. Pat. No. 6,360,698 and U.S. Pat. No. 6,575,120 where a wire-loop antenna is buried a few inches underground and defines an area in which the animal is to be contained or from which the animal is to be restricted. A receiver mounted on a collar placed around the neck of the animal includes one or more electrodes that are in physical contact with the skin of the animal. As the animal and receiver approach the wire-loop antenna, the receiver detects the radiated FSK signal. The received signal is measured and, if the received signal qualifies, a stimulus is applied to the animal. The stimulus may be an audible alert and/or an electric shock administered to the animal through the electrodes to train the animal to remain in the defined area.

While these systems have been successful in training animals with respect to remaining in the desired area, more information regarding a location of the animal with respect to the enclosed area is needed.

### BRIEF SUMMARY OF THE INVENTION

In one embodiment, a location of a device with respect to an area defined by an antenna is determined by receiving a repeating signal frame comprising a first frame portion followed by a second frame portion, the first frame portion being an inactive portion and the second frame portion comprising a cyclical signal; evaluating a first half-cycle of the cyclical signal immediately following the first frame portion; and determining, as a function of the first half-cycle evaluation, the location of the device with respect to the defined area.

In another embodiment, a system for determining a location of a movable device with respect to a predetermined area defined by an antenna wire from which a boundary signal having a repeating signal frame comprising an inactive interval followed by an active interval comprising a cyclical pattern is transmitted includes an antenna to receive the transmitted boundary signal and a splitter module, coupled to the antenna, configured to generate and output first and second signals as a function of the received boundary signal. A comparator module is coupled to the splitter module and configured to determine which of a first half-cycle portion of the first signal and a first half-cycle portion of the second signal reaches a first predetermined threshold value before the other and configured to output a location signal accordingly. A value of the location signal indicates one of the movable device being either within or not within the predetermined area.

### BRIEF DESCRIPTION OF THE SEVERAL VIEWS OF THE DRAWINGS

Various aspects of at least one embodiment of the present invention are discussed below with reference to the accompanying figures. It will be appreciated that for simplicity and clarity of illustration, elements shown in the drawings have not necessarily been drawn accurately or to scale. For example, the dimensions of some of the elements may be exaggerated relative to other elements for clarity or several physical components may be included in one functional block or element. Further, where considered appropriate, reference numerals may be repeated among the drawings to indicate corresponding or analogous elements. For purposes of clarity, not every component may be labeled in every drawing. The figures are provided for the purposes of illustration and explanation and are not intended as a definition of the limits of the invention. In the figures:

FIG. 1 is a functional block diagram of a prior art animal control system;

FIG. 2 is a functional block diagram of a collar used in the prior art animal control system of FIG. 1;

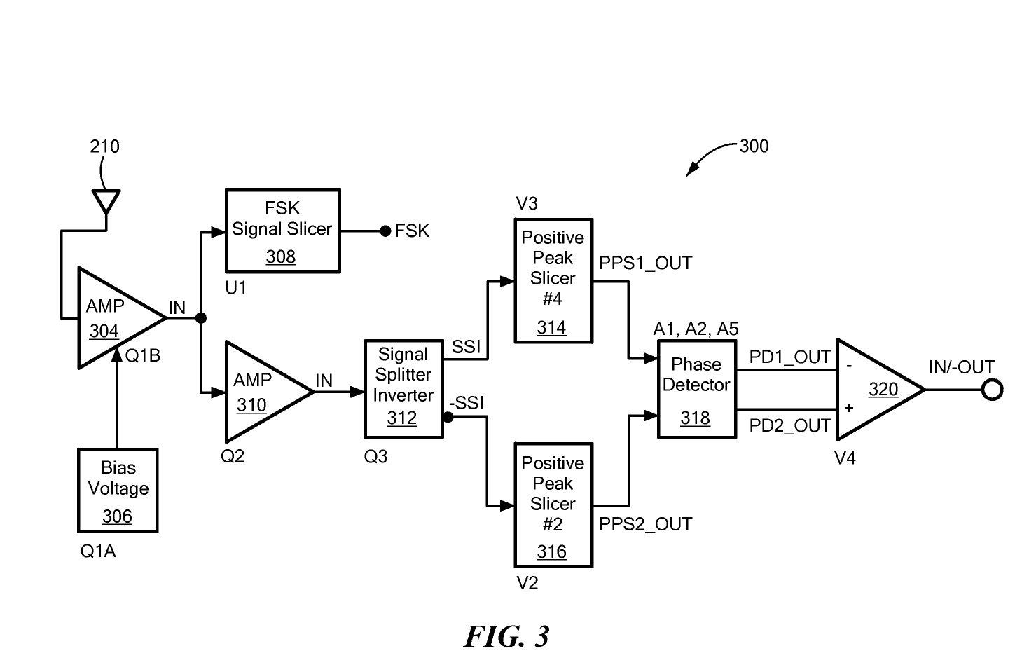

FIG. 3 is a functional block diagram of a loop phase detection system in accordance with an embodiment of the present invention;

FIGS. 4A-4F are signal waveforms found at nodes in the loop phase circuit of FIG. 3;

FIG. 5 is a circuit diagram of an embodiment of the loop phase detection system shown in FIG. 3;

FIG. 6 is a functional block diagram of a system in accordance with an embodiment of the present invention; and

FIG. 7 is a flowchart of a method in accordance with an embodiment of the present invention.

### DETAILED DESCRIPTION OF THE INVENTION

In the following description, numerous specific details are set forth in order to provide a thorough understanding of the embodiments of the present invention. It will be understood by those of ordinary skill in the art that these embodiments of the present invention may be practiced without some of these specific details. In other instances, well-known methods, procedures, components and structures may not have been described in detail so as not to obscure the embodiments of the present invention.

Prior to explaining at least one embodiment of the present invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein are for the purpose of description and should not be regarded as limiting.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

It will be helpful to understand known systems in order to understand the embodiments of the present invention described herein.

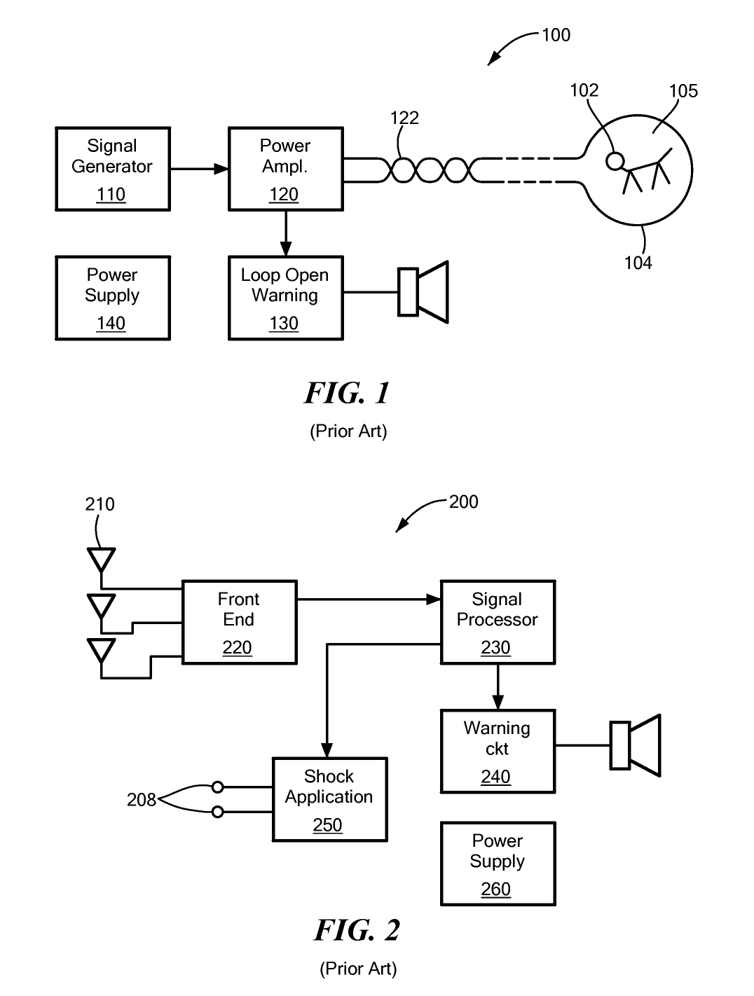

As shown in FIG. 1, a known system 100 for controlling the movement of an animal 102, typically a family pet and most commonly a dog, includes a wire-loop antenna 104 that is a cable buried in the ground and arranged to define an enclosed space 105.

A signal generator circuit 110 generates an FSK signal that is then amplified by a power amplifier circuit 120 and provided to the wire-loop antenna 104 via, for example, a twisted-wire connecting portion 122. As a result, the wire-loop antenna 104 operates as a simple magnetic field induction loop antenna to transmit the FSK signal. A loop-open warning circuit 130, and a power supply circuit 140 usually energized from a standard domestic source via an AC adapter, are also provided.

The second part of most known animal control systems is a receiver/stimulus (r/s) unit 200 that is usually in a collar placed around the neck of the animal 102. The r/s unit 200 applies a stimulus to the animal 102 upon detection of a qualified FSK signal indicating that the animal 102 is approaching the perimeter of the defined area 105. The typical animal learns very quickly to stay away from the perimeter and to either remain within, or stay outside of, the defined area.

The receiver/stimulus unit 200 comprises a collar antenna assembly 210 with, e.g., multiple antenna arranged along mutually orthogonal axes, a front-end circuit 220, a signal processor circuit 230, a warning circuit 240, a shock application circuit 250, coupled to electrodes 208, and a power supply circuit 260 which is battery powered.

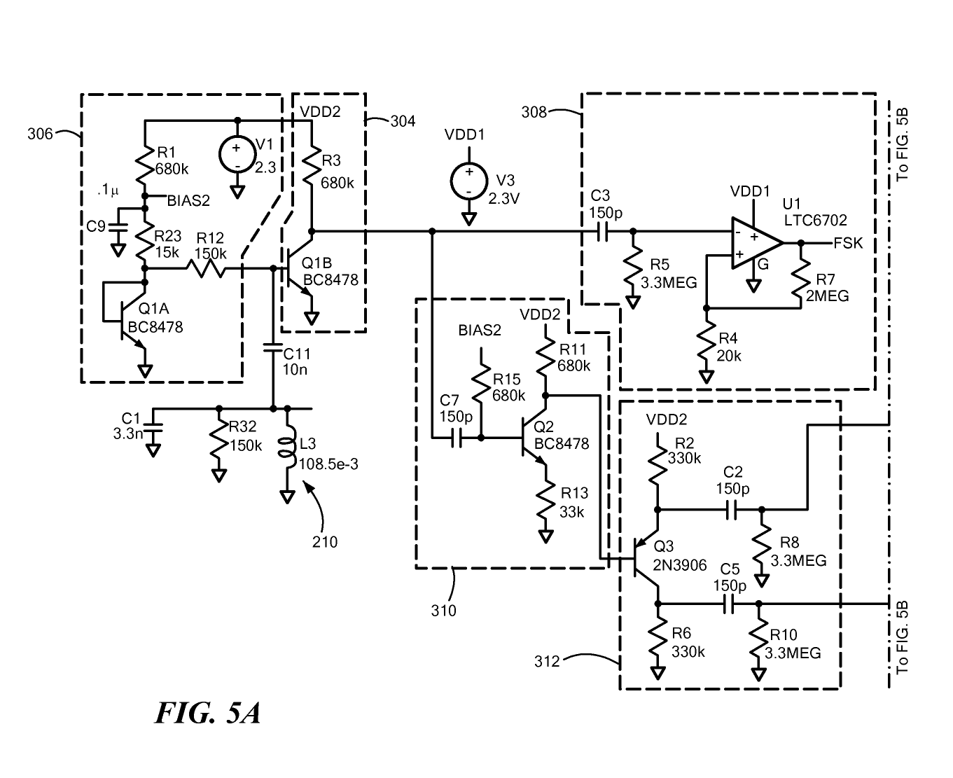

The FSK signal transmitted by the wire-loop antenna 210 has a power level set such that the r/s unit 200 generally only detects the signal within a certain detection distance from the wire 104. The portion of the defined area 105 in which the FSK signal is detected by the collar is referred to as the correction zone. Accordingly, when the animal 102 is where she belongs, no FSK signal is detected at the collar. As described in the '698 patent, for example, the FSK signal has a waveform as generally shown in FIG. 4A, with a basic 125 ms frame structure comprising a Mark Leader sequence and an interframe gap. The frame rate is eight frames per second and is transmitted continuously. U.S. Pat. Nos. 6,360,698 and 6,575,120, can provide more information as to the operation of these systems and each is incorporated herein by reference for all purposes.

While known systems perform adequately in identifying when the animal is approaching the boundary, known systems do not provide an indication of where the animal is once the collar has detected the FSK signal. In other words, when the collar detects the FSK signal, known systems can only indicate that the animal is within the detection distance of the wire but cannot determine on which side of the boundary line the animal is located because the FSK signal can be detected either inside or outside the defined boundary area if the collar is within the detection distance from the wire.

The inventor recognized that the location of a pet with respect to the boundary wire could be ascertained if a phase of the received signal from the wire-loop antenna was determined. Since the r/s unit 200 has no absolute phase reference, however, it is not possible to determine the phase from a steady state signal. If there is an interruption in a continuous signal, however, observing the signal during the active interval immediately after the interruption can indicate where the collar is located. Advantageously, the polarity of the waveform revealed during the first half cycle of the Mark Leader sequence of the FSK signal, immediately after the interruption, i.e., the gap can be used to determine the location, as will be described in more detail below.

The known FSK frame includes an interruption in an otherwise continuous signal. Specifically, the gap portion of the FSK frame is immediately prior to the cyclical portion of the frame as shown in FIG. 4A. Thus, during the first half cycle A1, A2 and A3, as will be described in more detail below, the location of the collar and, therefore, the animal wearing the collar with respect to the enclosure, can be determined.

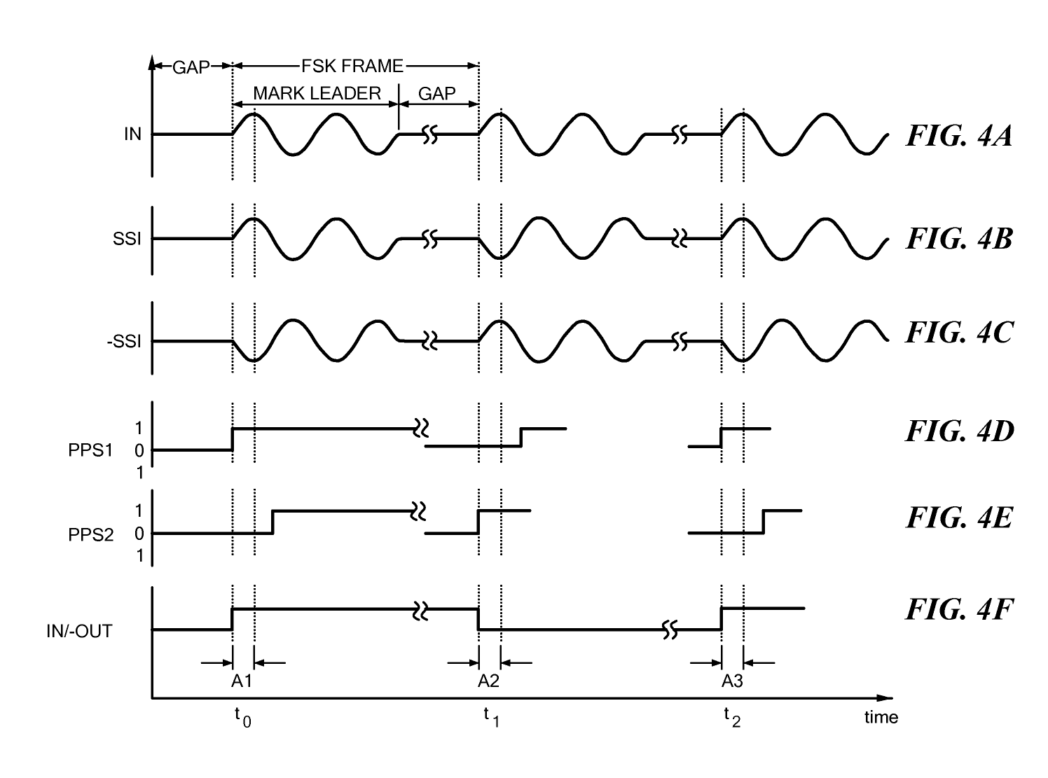

In one embodiment, a phase determination circuit 300, referring to FIG. 3, is provided as an additional portion in the collar. In operation. the collar antenna 210 receives the FSK signal transmitted by the wire-loop antenna 104. It should be noted that only one antenna 210 is shown for ease of explanation but that multiple antennae may be used. The collar antenna 210 is coupled to an input of a first amplifier 304 that receives a bias voltage from the bias voltage module 306. An output signal IN is provided to an FSK signal slicer 308 as well as to a second amplifier 310. The FSK signal slicer 308 generates the FSK signal information that is used by the animal control system as is known. One use of this generated FSK signal is a determination that the signal actually being received by the collar is a genuine signal in that it includes the appropriate encoded information.

The output of the second amplifier 310, i.e., the IN signal, is provided to a signal splitter/inverter 312. The signal splitter/inverter 312 outputs two signals SSI and −SSI that are provided, respectively, to a first positive peak slicer 314 and a second positive peak slicer 316. The output of the first positive peak slicer 314, PPS1_OUT, and the output of the second positive peak slicer 316, PPS2_OUT, are provided to a phase detector 318. The phase detector 318 provides two output signals PD1_OUT and PD2_OUT. Finally, a comparator 320 then identifies which of the two signals PD1_OUT and PD2_OUT has the first positive going portion.

Operation of the phase determination circuit 300 will now be described in more detail with respect to FIGS. 4A-4F. Referring now to FIG. 4A again, the signal IN represents the output of the second amplifier 310 and the input to the signal splitter/inverter 312. The signal splitter/inverter 312 provides the two outputs SSI and −SSI which are, respectively, in phase and out of phase versions of the IN signal as shown in FIGS. 4B and 4C.

At time t₀, the animal is, in this example, within the enclosure but near enough to the wire-loop antenna 104 to detect the FSK signal. Each of the first and second positive peak slicers 314, 316 determines when the respective SSI and −SSI signal has a positive going phase. As shown in FIGS. 4D and 4E, in the first half cycle portion A1 at time to, the SSI signal has the first positive going phase as detected by the first positive peak slicer 314. By operation of the phase detector 318 and the output amplifier 320, the IN/−OUT signal goes to the high level indicating that the animal, although within range of the enclosure wire, i.e., the wire-loop antenna, is still within the enclosed space.

It should be noted that the system has been normalized to this state in that when the SSI signal goes positive prior to the −SSI signal, the animal is identified as being within the enclosure. As the collar is a loop antenna within the loop antenna 104, this will always be the case.

If the animal were, somehow, able to overcome the shocks and other indications used to keep her away from the perimeter and actually pass outside the enclosed area 105 then, at time t₁, for example, because the collar is now outside the enclosure, but still within range to receive the FSK signal, the signals SSI and −SSI would be inverted, see A2, from that shown at time t₀. As a result, the output signal IN/−OUT will go low thus indicating that the animal is now outside the enclosure.

Subsequently, if the animal were to recognize the error of her ways and return inside the enclosure at, for example, time t₂, then the signals SSI and −SSI would be as shown during the time period A3 and the output signal IN/−OUT would then indicate that the animal is inside the enclosure.

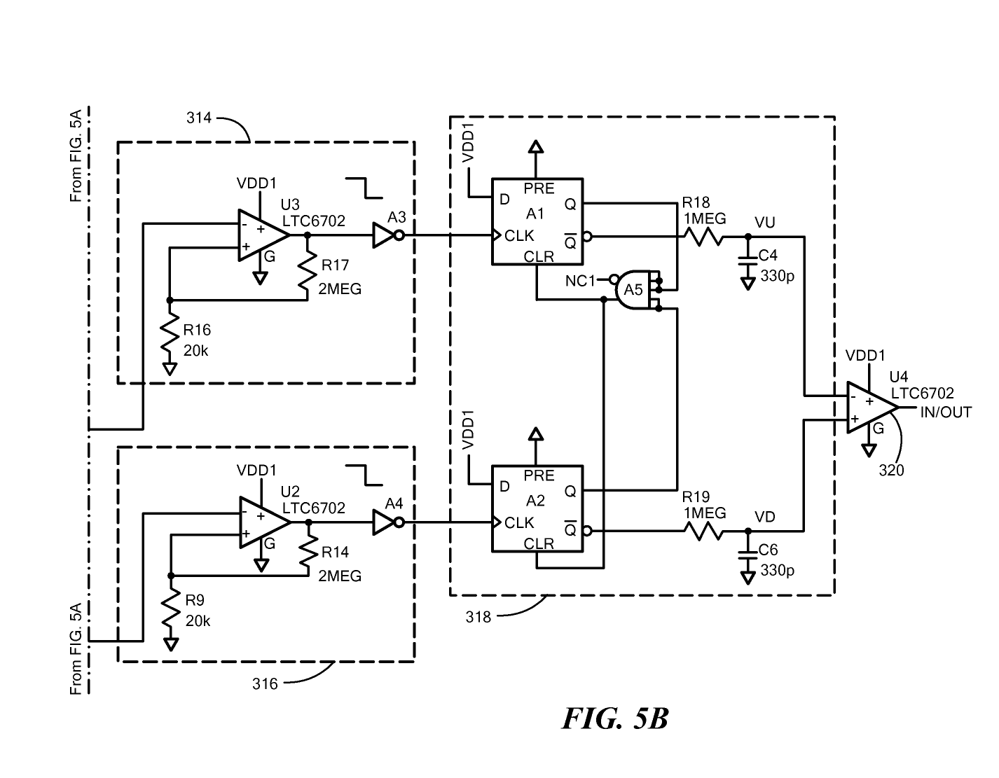

In one embodiment of the present invention, the functional blocks shown in FIG. 3 are implemented by discrete devices as shown in FIG. 5. A coil L3 functions as one of the antennae 210 and, as above, additional antenna coils may be used for multiple axis operations, however, one coil is shown for simplicity of explanation. A capacitor C1 may be used to tune the antenna coil 210 to resonate with a received signal in the range of 4 to 10 kilohertz (kHz), where 4 or 8 kHz is typical. In one embodiment, an 8 kilohertz signal is used and the tuning provides additional signal pickup and rejection of signals away from the 8 kilohertz frequency. A resistor R32 provides for an increase in the usable resonant bandwidth and reduces the ring up time of the recovered signal.

In one embodiment, the bias voltage module 306 includes a transistor Q1A operating in conjunction with a resistor R1 and another resistor R23 to provide a temperature-compensated bias voltage to transistor Q1B as part of the first amplifier module 304 and a transistor Q2 operating as part of the second amplifier module 310. The transistor Q1B provides 28 decibels of gain in order to operate the FSK signal slicer 308 that is implemented by comparator U1 in conjunction with resistors R4 and R7. In this embodiment, a signal level of an approximately 25 millivolt peak is required to operate the FSK signal slicer 308.

The transistor Q2 operates as an amplifier to provide approximately 15 decibels of gain that is necessary to compensate for any signal level lost due to the ring up time constant of the resonant antenna 210.

The signal splitter/inverter 312 comprises a transistor Q3 operating in conjunction with resistors R2 and R6 to implement a 180° splitter. The in phase signal SSI appears at the emitter of the transistor Q3 while an inverted copy of the signal, i.e., −SSI appears at the collector of transistor Q3. Two signal comparators U2 and U3 trigger on positive signals and ignore negative peaks.

As discussed above, an in-phase signal that is picked up by the antenna coil L3 will produce a positive going signal at the input to the first positive peak slicer 314 and a negative going signal at the second positive peak slicer 316. As each of these slicers triggers on positive signals, the first positive peak slicer 314 will be the first to trigger when the animal is inside the enclosure. As a result, the signals fed to a first Flip-Flop A1 at its CLK input will lead the signal fed to the second Flip-Flop A2 by one-half of a signal cycle.

Effectively, the circuit operates to determine which signal reaches a predetermined threshold level first. That determination identifies where the collar, i.e., the animal, is located with respect to the defined area.

When the animal is outside the enclosure, the signal picked up by the antenna coil L3 will produce a negative going signal at the input to the first positive peak slicer 314 and a positive going signal at the second positive peak slicer 316 will then be the first to trigger. As a result, the signal fed to the Flip-Flop A1, at its CLK input will lag the signal fed to the second Flip-Flop A2 by one-half of a signal cycle and indicate that the animal is outside the enclosure.

Two resistors R18 and R19 operate in conjunction with the corresponding capacitors C4 and C6, respectively, to deglitch the outputs from the Flip-Flops A1, A2. A comparator U4 arbitrates the dual output Flip-Flop phase detector into a single bi-directional output, i.e., IN/−OUT.

In another embodiment of the present invention, the function of the phase detector 318 may be implemented by a micro-controller. Further, while the embodiments described herein reference discrete devices, it is envisioned that alternate devices, for example, but not limited to, ASICs, digital-to-analog converters, analog-to-digital converters, multiplexors, micro-controllers, FPLA devices, etc., could be used as well.

Advantageously, by being able to determine whether the animal is inside or outside the enclosure, additional operations may be implemented. These operations may include, but are not limited to, initiating a radio or text message from the collar including location information, for example, from a GPS locator, in order to allow for locating and retrieving the animal. This may aid in situations where the animal has either wandered off or has been taken.

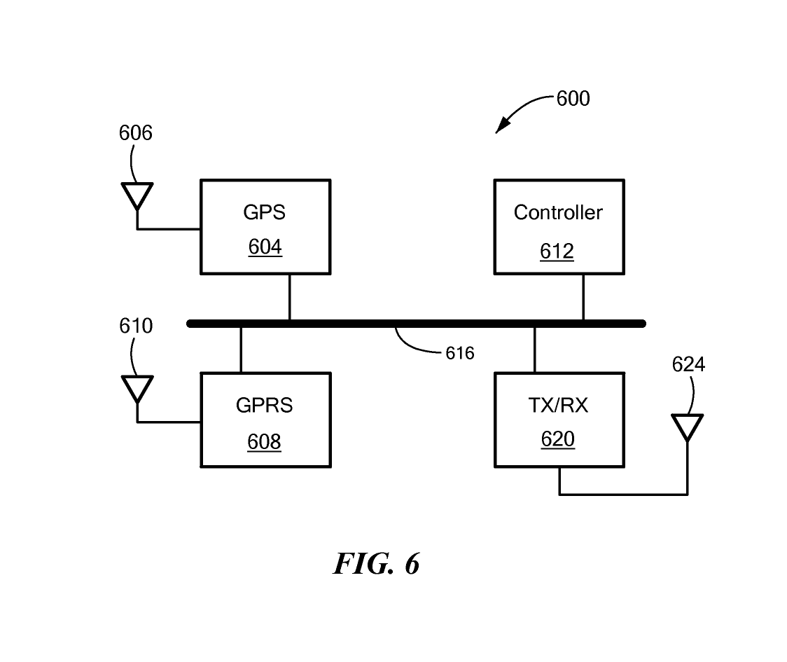

More specifically, referring now to FIG. 6, in another embodiment of the present invention, the collar may include a locator module 600 that functions to report the location of the animal if she were to leave, or be taken from, the defined area 105. The locator module 600 includes a global positioning system (GPS) module 604 as is known in the art for receiving global positioning information in order to determine location. A corresponding antenna 606 is coupled to the GPS Module 604. In addition, in one embodiment, a GPRS (General Packet Radio Service) module 608 that operates to transmit messages, for example, SMS text messages or the like, is also provided and coupled to a corresponding antenna 610. GPRS, as known by one of ordinary skill in the art, is a packet oriented mobile data service on the 2G and 3G cellular communication system. Further, a transmitter/receiver (TX/RX) module 620, and a corresponding antenna 624, is provided for communicating on another channel, different from the GPRS module 608, with a home base system associated with the enclosure system. A micro-controller 612 is coupled to each of the GPS 604, the GPRS 608 and the TX/RX module 620 via a bus 616 in order to control and communicate with each of these devices as well as implement the method as described below. Of course, one of ordinary skill in the art would understand that these modules may be coupled to one another in a different configuration, as known in the art, from that which is shown, which is merely exemplary. The locator module 600 may be provided in the collar that the animal is wearing and integrated with other components as described herein. Further, rather than individual antennae 606, 610, one of ordinary skill in the art would understand that a single multi-band antenna may be used.

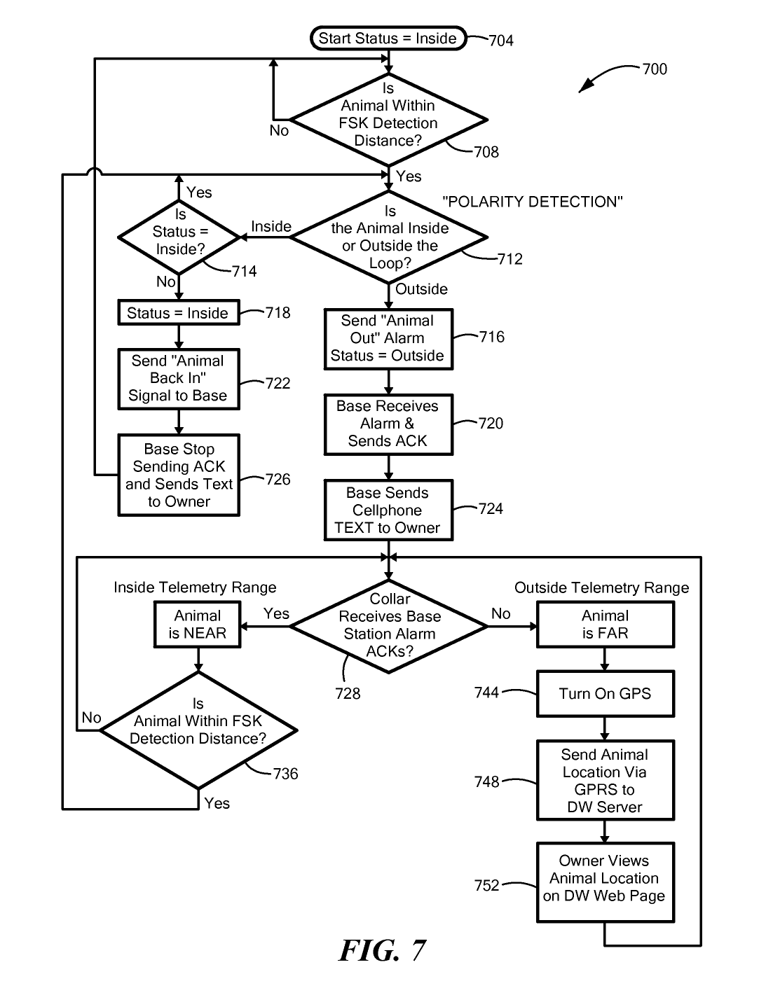

Referring now to FIG. 7, a method 700 of operation in which the location of an animal once it has left the defined zone will now be described. The system is initialized, step 704, and, assuming that the animal starts out within the enclosure, and away from the correction zone, an initial status set to “inside.” A determination is next made as to whether or not the animal is in the correction zone, step 708, i.e., determining if the FSK signal is found and this step may be repeated until the FSK signal is detected.

When the FSK signal is detected at step 708 then control passes to step 712 where the determination is made as to whether or not the animal is inside or outside the defined area. This determination of inside versus outside, in one embodiment, is based on the polarity detection as has been described above. More specifically, the IN/−OUT signal from the comparator 320 may be coupled, either directly or through the bus 616, to the controller 612 as an input signal. If it is determined that the animal is inside the loop, but within the correction zone, the animal may be provided with a correction signal, for example, a shock from the collar, in order to encourage the animal to move away from the boundary.

If, however, at step 712, it is determined that the animal is outside the loop, then control passes to step 716 where the collar transmitter sends an alarm signal indicating that the animal is out and sets its status as being “outside” the boundary. Subsequently, at step 720, a base system receives the animal out alarm signal and sends an acknowledgement (ACK) signal. The ACK signal may be repeatedly sent once the base receives the alarm signal. In addition, step 724, the base system sends a cell phone text to the owner reporting that the animal has been detected as being outside the boundary.

Next, at step 728, as the collar's status is “outside” the collar determines whether or not it is receiving the base station alarm ACK signals. If the collar is receiving the alarm acknowledgement signals, then the status is that the animal is “near” but still outside. Subsequently, control passes to step 736 where a determination is made as to whether or not the collar is receiving the FSK signal indicating that the animal is outside the boundary but within the detection distance. If the FSK signal is still being received, then control passes back to step 712 to determine if the animal is inside or outside of the boundary.

Alternatively, if the collar is not receiving the FSK signal, then control turns back to step 728 to determine if the collar is receiving the base station alarm acknowledgement signals.

If, at step 728, the base station alarm ACK signals are not being received, the animal is now outside the boundary and is farther away than the FSK detection distance. Control then passes to step 744 where the GPS module is turned on in order to collect the satellite information identifying where the animal is currently located. At step 748, the animal location information is sent via the GPRS module 608 to a central server that is configured to receive the signal from the collar. Subsequently, step 752, the owner of the animal may access the server, for example, via a web page on the internet, in order to view the animal's location. Control then returns to step 728 to determine if, perhaps, the animal has wandered back toward the enclosure.

Returning now to step 712, if it is determined that the animal is inside then control passes to step 714 where the current status is checked. If the current status is “inside” then control returns to step 712. If the current status is not “inside,” i.e., it is “outside” then control passes to step 718 where the current status is reset to “inside.” Next, step 722, the collar sends a signal to the base indicating that the animal is now “back inside” and, subsequently, step 726, the base notifies the owner and stops sending the ACK signal to the collar.

Having thus described several features of at least one embodiment of the present invention, various alterations, modifications and improvements will readily occur to those skilled in the art. Such alterations, modifications and improvements are intended to be part of this disclosure and are within the scope of the invention. The foregoing description and drawings are by way of example only, and the scope of the invention should be determined from proper construction of the appended claims, and their equivalents as the invention is not to be limited by what has been particularly shown and described, except as indicated by the appended claims.

What is claimed is:

1. A method of determining a location of a movable device with respect to a defined area, the method comprising:
receiving a repeating signal frame, the repeating signal frame comprising a first frame portion followed by a second frame portion, the first frame portion being an inactive portion and the second frame portion comprising a cyclical signal;
evaluating a first half-cycle portion of the cyclical signal immediately following the first frame portion; and
determining, as a function of the first half-cycle portion evaluation, the location of the movable device with respect to the defined area.

2. The method of claim 1, wherein evaluating the first half-cycle portion comprises:
generating an inverted version of the cyclical signal;
comparing a first half-cycle portion of the cyclical signal to a first half-cycle portion of the inverted cyclical signal; and
determining which of the two first half-cycle portions comprises a first rising edge signal component.

3. The method of claim 2, further comprising:
determining that the movable device is within the defined area if the cyclical signal has the first rising edge signal component; and
determining that the movable device is not within the area if the inverted cyclical signal has the first rising edge signal component.

4. The method of claim 2, further comprising:
determining that the movable device is within the defined area if the cyclical signal has the first falling edge signal component; and
determining that the movable device is not within the area if the inverted cyclical signal has the first falling edge signal component.

5. The method of claim 1, further comprising:
defining the area by placing an antenna wire.

6. The method of claim 5, further comprising:
transmitting the repeating signal frame via the antenna wire.

7. A method of determining a location of a movable device with respect to a defined area, the method comprising:
transmitting a repeating signal frame comprising a first frame portion followed by a second frame portion, the first frame portion being an inactive portion and the second frame portion comprising a cyclical signal;
receiving the repeating signal frame;
evaluating a first half-cycle of the cyclical signal immediately following the first frame portion; and
determining, as a function of the first half-cycle evaluation, the location of the movable device with respect to the defined area.

8. The method of claim 7, further comprising:
defining the area by placing an antenna wire.

9. The method of claim 8, further comprising:
transmitting the repeating signal frame from the antenna wire.

10. The method of claim 7, wherein evaluating the first half-cycle comprises:
generating an inverted version of the cyclical signal;
comparing a first half-cycle portion of the cyclical signal to a first half-cycle portion of the inverted cyclical signal; and
determining which of the two first half-cycle portions comprises a first rising edge signal component.

11. The method of claim 10, further comprising:
determining that the movable device is within the area if the cyclical signal has the first rising edge signal component; and
determining that the movable device is not within the area if the inverted cyclical signal has the first rising edge signal component.

12. The method of claim 7, wherein evaluating the first half-cycle comprises:
generating an inverted version of the cyclical signal;
comparing a first half-cycle portion of the cyclical signal to a first half-cycle portion of the inverted cyclical signal; and
determining which of the two first half-cycle portions comprises a first falling edge signal component.

13. The method of claim 12, further comprising:
determining that the movable device is within the area if the cyclical signal has the first falling edge signal component; and
determining that the movable device is not within the area if the inverted cyclical signal has the first falling edge signal component.

14. A method of determining a location of a movable device with respect to a predetermined area defined by an antenna wire, the method comprising:
transmitting, on the antenna wire, a boundary signal having a repeating signal frame comprising an inactive interval followed by an active interval comprising a cyclical pattern;
receiving the transmitted boundary signal;
evaluating a first half-cycle portion of the cyclical pattern immediately following the inactive interval; and
determining the location of the movable device with respect to the predetermined area as a function of the first half-cycle portion evaluation.

15. The method of claim 14, wherein evaluating the first half-cycle portion of the cyclical pattern comprises:
generating a non-inverted version of the received boundary signal;
generating an inverted version of the received boundary signal;
comparing a first half-cycle portion of the non-inverted boundary signal to a first half-cycle portion of the inverted boundary signal; and
determining which one of the two generated first half-cycle portions reaches a predetermined threshold value prior to the other.

16. The method of claim 15, further comprising:
setting the first predetermined threshold value to one of a positive value and a negative value.

17. The method of claim 15, further comprising:
determining that the location of the movable device is within the predetermined area if it is determined that the first half-cycle portion of the non-inverted signal reaches the first predetermined threshold prior to the first half-cycle portion of the inverted signal.

18. The method of claim 14, further comprising:
generating first and second generated signals as a function of the received signal;
comparing a first half-cycle portion of the first generated signal to a first half-cycle portion of the second generated signal; and
determining which one of the two generated first half-cycle portions reaches a first predetermined threshold value prior to the other.

19. The method of claim 18, wherein generating the first and second generated signals comprises:
generating a non-inverted version of the received signal; and
generating an inverted version of the received signal.

20. A system for determining a phase of a transmitted periodically interrupted cyclical first signal, the system comprising:
a signal splitter/inverter module configured to receive the first signal and to output a non-inverted version of the first signal and an inverted version of the first signal;
a positive peak slicer module coupled to the signal splitter/inverter and configured to output first and second slicer signals indicating, respectively, when each of the non-inverted and inverted signals first has a positive-going portion subsequent to the periodic interruption; and
a comparator coupled to the positive peak slicer module and configured to output a signal indicating which of the non-inverted and inverted signals was positive-going prior to the other.

21. The system of claim 20, wherein the first signal is transmitted through the air, the system further comprising:
an antenna to receive the transmitted first signal.

22. The system of claim 21, wherein:
the signal splitter/inverter module is coupled to the antenna.

23. A system for determining a location of a movable device with respect to a predetermined area defined by an antenna wire from which a boundary signal having a repeating signal frame comprising an inactive interval followed by an active interval comprising a cyclical pattern is transmitted, the system comprising:
an antenna to receive the transmitted boundary signal;
a splitter module, coupled to the antenna, configured to generate and output first and second signals as a function of the received boundary signal; and
a comparator module, coupled to the splitter module, and configured to determine which of a first half-cycle portion of the first signal and a first half-cycle portion of the second signal reaches a first predetermined threshold value before the other and configured to output a location signal accordingly,
wherein a first value of the location signal indicates the movable device being within the predetermined area and a second value of the location signal indicates the movable device being not within the predetermined area.

24. The system of claim 23, wherein the splitter module is further configured to:
output the first and second signals as a non-inverted and inverted version of the received boundary signal, respectively.

25. The system of claim 23, wherein the first predetermined value is one of a positive and a negative value.

26. The system of claim 23, further comprising:
a tracking module coupled to the comparator module to receive the location signal,
wherein the tracking module is configured to transmit geographic location information corresponding to the movable device in response to the location signal being at the second value.

27. The system of claim 26, wherein the tracking module comprises:
a GPS device; and
a GPRS device.

28. The method of claim 3, upon determining that the movable device is not within the area, further comprising:
enabling a GPS device and obtaining geographic location information corresponding to the movable device therefrom; and
transmitting the obtained geographic location information to a predetermined receiving address.

29. The method of claim 7, further comprising:
determining, as a function of the first half-cycle evaluation, that the location of the movable device is outside the defined area; and
in response to the determination, transmitting geographic location information corresponding to the movable device to a predetermined receiving address.

30. A wearable collar for determining a location of a corresponding animal with respect to a predetermined area defined by an antenna wire from which a boundary signal having a repeating signal frame comprising an inactive interval followed by an active interval comprising a cyclical pattern is transmitted, the collar comprising:
an antenna to receive the transmitted boundary signal;
a splitter module, coupled to the antenna, configured to generate and output first and second signals as a function of the received boundary signal;
a comparator module, coupled to the splitter module, and configured to determine which of a first half-cycle portion of the first signal and a first half-cycle portion of the second signal reaches a first predetermined threshold value before the other and configured to output a location signal with a first value or a second value, respectively; and
a tracking module coupled to the comparator module to receive the location signal and configured to transmit geographic location information corresponding to the collar in response to the location signal being at the second value,
wherein the first value of the location signal indicates the collar being within the predetermined area and the second value of the location signal indicates the collar being not within the predetermined area.

31. The wearable collar of claim 30, wherein the tracking module further comprises:
a GPS device; and
a GPRS device,
wherein the tracking module is further configured to maintain at least one of the GPS device and the GPRS device without power until the location signal at the second value is received from the comparator module.
